(19) United States
(12) Patent Application Publication
(10) Pub. No.: US 2026/0145927 A1
(43) Pub. Date: May 28, 2026

(54) FUEL DISPENSING COLUMN WITH AN INCLINED BREAKAWAY COUPLING

(71) Applicant: DOVER FUELING SOLUTIONS UK LIMITED, Edinburgh (GB)

(72) Inventors: Bengt I. LARSSON, Skivarp (SE); Eva-Lie EDVARDSSON, Sölvesborg (SE)

(21) Appl. No.: 19/122,126

(22) PCT Filed: Nov. 8, 2023
(86) PCT No.: PCT/EP2023/081154

§ 371 Date: Apr. 17, 2025

(30) Foreign Application Priority Data
Nov. 14, 2022 (SE) 2251337-8

(51) Int. Cl. B67D 7/32; B67D 7/04; F17C 5/00

(52) U.S. Cl. CPC B67D 7/3218; B67D 7/04; F17C 5/007; F17C 2205/0323; F17C 2205/0364; F17C 2205/037; F17C 2221/012; F17C 2221/033; F17C 2265/065

(57) ABSTRACT

The invention relates to a fuel dispensing unit (1) for refuelling a vehicle, comprising a breakaway device (3) comprising a first shut-off valve unit (4) connected to a fuel supply line of the fuel dispensing unit (1) and a second shut-off valve unit (5) connected to a first end (6) of a fuel hose (7), the fuel hose (7) comprising a fuel nozzle (2) at a second end of the fuel hose (7). The first shut-off valve unit (4) and the second shut-off valve unit (5) are intended to be disconnected when a predetermined tractive force from the fuel hose (7) is exceeded to separate the fuel hose (7) from the fuel dispensing unit (1). The fuel dispensing unit (1) comprises a tilting means (8) fixed to an outer side portion (9) of the fuel dispensing unit (1) and supporting the breakaway device (3), such that the breakaway device (3) is inclined at a predetermined angle (α) with respect to the outer side portion (9) of the fuel dispensing unit (1).

### CROSS-REFERENCE TO RELATED APPLICATIONS

This application is a U.S. National Stage Application under 35 U.S.C. § 371 of International Patent Application No.: PCT/EP2023/081154, filed on Nov. 8, 2023, which claims priority to Swedish Patent Application No. 2251337-8, filed Nov. 14, 2022, the entire contents of each of which are hereby incorporated by reference herein in their entirety.

### TECHNICAL BACKGROUND

The present invention relates generally to fueling stations and, more particularly, to a fuel dispensing unit comprising a breakaway device for shutting down the fuel dispensing unit when a vehicle drives away with the dispensing hose of the fuel dispensing unit attached thereto.

### BACKGROUND ART

Both alternative fuels, such as hydrogen and liquid natural gas (LNG), and more conventional fuels, such as gasoline or diesel, are dispensed to vehicles via fueling stations. A fueling station typically includes a storage tank connected to at least a fuel dispensing unit comprising a fuel hose with a coupling or a nozzle that may be removably connected to a vehicle fueling port. The fuel dispensing unit comprises a pump the storage tank and the fuel hose for transferring the fuel from the storage tank to the vehicle tank.

In the case of hydrogen or other cryogenic fuels as LNG, the fueling station typically includes a conditioning arrangement so that the fuel (gas in this case) may be warmed and/or pressurized before delivery to the vehicle under high pressure, typically 350 bars or 700 bars. The conditioning arrangement is connected to at least a fuel dispensing unit. The conditioning arrangement supply gas in liquid state to the fuel dispensing unit that delivers gas under gaseous state to the vehicle.

Safety aspects in and around areas containing fuel or gas dispensing units is today a highly debated field and new technology is constantly developed with the intention to increase the safety within such areas. It is well-known that fuel, such as gasoline, diesel or hydrogen, is a highly inflammable substance that must be handled with extreme care. An inherent property of fuel, that increases the risks of its handling, is its high volatility. For the above reasons, safety standards such as the UL standards for safety in North America, the ATEX directive in the EU or the international standard ISO 19880-1 pertaining to hydrogen filling stations have been created to reduce the thereby induced risks.

One specific safety issue in and around areas containing fuel dispensing units is the problem of customers driving off with the nozzle still remaining in the vehicle which has been refuelled. This problem is normally solved by arranging a breakaway device between the fuel supply line of the fuel dispensing unit and the fuel hose. A breakaway device includes two pieces which are intended to uncouple when a vehicle drives away from the fuelling station with the dispensing hose nozzle or coupling still connected to the vehicle. Breakaway devices are commonly installed with one piece connected to the fuel dispensing unit and the other piece connected to the end of the fuel hose that is opposite to the end equipped with the coupling or nozzle.

EP 1306347 B1 discloses an example of a breakaway device for a fuelling station. The breakaway device includes a pair of leg members that are joined by their proximal ends to the dispensing hose portions. The distal ends of the leg members are joined at an angle to a frangible member that includes a pair of inner segments that are joined in an abutting fashion by a surrounding frangible sleeve. When a driveaway occurs, the leg members are pulled apart and exert a bending moment on the frangible member. As a result, the frangible member breaks which prevents significant damage to the station.

A problem with existing and fixed breakaway solutions is that the fuel hose will abut directly against the column of the fuel dispensing unit when a drive off situation occurs. This will cause high forces onto the column and the nozzle still present in the vehicle. Extensive damages on the fuel dispensing unit and the vehicle in question will be a direct consequence.

### SUMMARY ON THE INVENTION

It is an objective of the present invention to mitigate, alleviate or eliminate one or more of the above-identified deficiencies in the art and disadvantages singly or in any combination and solve at least the above-mentioned problems.

According to a first aspect of the invention, these and other objects are achieved, in full or at least in part, by a fuel dispensing unit for refuelling a vehicle, comprising a breakaway device comprising a first shut-off valve unit connected to a fuel supply line of the fuel dispensing unit and a second shut-off valve unit connected to a first end of a fuel hose, the fuel hose comprising a fuel nozzle at a second end of the fuel hose. The first shut-off valve unit and the second shut-off valve unit are intended to be disconnected when a predetermined tractive force from the fuel hose is exceeded to separate the fuel hose from the fuel dispensing unit. The fuel dispensing unit comprises a tilting means fixed to an outer side portion of the fuel dispensing unit and supporting the breakaway device, such that the breakaway device is inclined at a predetermined angle with respect to the outer side portion of the fuel dispensing unit.

This is advantageous in that the force applied from the fuel hose onto other parts of the fuel dispensing unit, primarily onto the outer side portion at which the breakaway device is arranged, as well as on the vehicle in question, will be significantly less when a drive off occurs.

To avoid having a large top module to allow for space between the breakaway device and the outer side portion of the fuel dispensing unit, the breakaway device is instead arranged at angle in relation thereto.

The invention is particularly applicable for hydrogen dispensers.

The fuel dispensing unit may further comprise a hose guiding means having a first portion connected to the second shut-off valve unit of the breakaway device and a second portion comprising a hose outlet, wherein the hose guiding means is arranged in connection with the tilting means such that the second portion of the guiding means is positioned at a predetermined distance D from the outer side portion of the fuel dispensing unit.

As said above, without the tilting means, it would have been necessary to use a larger top box to keep the predetermined distance D between the outer side portion of the fuel dispensing unit and the second portion of the hose guiding means.

Further, during a drive-off, the second shut-off valve unit passes through the hose guiding means and is thus guided by the hose guiding means and deviated in a direction opposite to the column.

The hose guiding means may comprise a tube element.

The tube element enables to protect and to guide the hose in a simple manner.

The fuel dispensing unit according to any one of the preceding claims, wherein the tilting means comprises a triangular support element having a triangular section and onto which the breakaway device is arranged.

The triangular support provides a simple and cheap means for tilting the breakaway.

The triangular support element may comprise a first section having a first outermost width which is located near the first shut-off valve unit and a second section having a second outermost width which is located near the second portion of the guiding means, the first outermost width being smaller than the second outermost width.

The first section and the second section may be spaced apart in a vertical direction.

The tube element may be fixed to the triangular support element with a fixing means.

The predetermined angle between the inclined breakaway device and the outer side portion of the fuel dispensing unit may preferably be within the range of 10 degrees and 40 degrees.

The predetermined distance between the second portion of the hose guiding means and the outer side portion of the fuel dispensing unit may preferably be within the range of 70 mm to 100 mm.

It has been investigated that if the distance between the second portion of the hose guiding means and the outer side portion of the fuel dispensing unit is 80 mm or more, the force on the outer side portion will be significantly less.

The outer side portion of the fuel dispensing unit may be constituted by a column extending vertically between a top module and a nozzle boot module of the fuel dispensing unit.

The inclined breakaway device may be arranged on the outer side portion such that the second shut-off valve unit of the breakaway device is oriented toward the nozzle boot module of the fuel dispensing unit.

This configuration is preferred because it provides a simpler arrangement for connecting the breakaway to the fuel supply line outlet which is usually located in the top box.

Alternatively, the inclined breakaway device may be arranged on the outer side portion such that the second shut-off valve unit of the breakaway device is oriented toward the top module of the fuel dispensing unit.

This configuration is more complex but enables to reduce the length of the fuel supply line and thus the cost.

An elastic element may be connected to the fuel hose at one end and to the fuel dispensing unit at the other end, the elastic element being adapted to pull the fuel hose towards the fuel dispensing unit.

The tilting means and at least a part of the guiding means may be protected by a cover.

The cover protects the tilting means, at least a part of the guiding means and a part of the breakaway and also improves the aesthetic.

Effects and features of the second aspect of the present invention are largely analogous to those described above in connection with the first aspect of the inventive concept. Embodiments mentioned in relation to the first aspect of the present invention are largely compatible with the further aspects of the invention.

Other objectives, features and advantages of the present invention will appear from the following detailed disclosure, from the attached claims, as well as from the drawings. It is noted that the invention relates to all possible combinations of features.

Generally, all terms used in the claims are to be interpreted according to their ordinary meaning in the technical field, unless explicitly defined otherwise herein. All references to “a/an/the [element, device, component, means, step, etc.]” are to be interpreted openly as referring to at least one instance of the element, device, component, means, step, etc., unless explicitly stated otherwise.

As used herein, the term “comprising”, and variations of that term are not intended to exclude other additives, components, integers, or steps.

### BRIEF DESCRIPTION OF THE DRAWINGS

The above, as well as additional objects, features and advantages of the present invention, will be better understood through the following illustrative and non-limiting detailed description of embodiments of the present invention, with reference to the appended drawings, where the same reference numerals may be used for similar elements, and wherein:

FIG. 1A is a perspective view of one exemplary embodiment of a fuel dispensing unit according to the invention.

FIG. 1B is an enlargement view of a portion of the fuel dispensing unit in FIG. 1A according to one exemplary embodiment.

FIG. 1C is a front view of the fuel dispensing unit in FIG. 1A.

FIG. 1D is an enlargement view of a portion of the fuel dispensing unit according to another exemplary embodiment.

FIG. 2A is a perspective view of another exemplary embodiment of a fuel dispensing unit according to the invention.

FIG. 2B is an enlargement view of a portion of the fuel dispensing unit in FIG. 2A according to one exemplary embodiment.

### DETAILED DESCRIPTION OF PREFERRED EMBODIMENTS OF THE INVENTION

The invention relates to a fuel dispensing unit 1 for refuelling a vehicle. Both alternative fuels, such as hydrogen or liquid natural gas (LNG), and more conventional fuels, such as gasoline or diesel, are dispensed to vehicles via fuel dispensing units 1.

A fuel dispensing unit 1 for dispensing conventional fuels normally has a pumping system (not shown) which is used to supply fuel from an underground storage tank (not shown) to one or more fuel nozzles 2 for filling up a vehicle with fuel. Each tank of the two or more fuel storage tanks may store a different type of fuel, such as petrol, diesel, and biodiesel. In the case of two or more fuel storage tanks, the fuel dispensing unit 1 may comprise two or more pumping systems, one for each fuel storage tank. In addition, two or more fuel dispensing units may be connected to the same fuel storage tank.

In the case of hydrogen or other cryogenic fuels such as LNG, the fuelling station typically includes a conditioning arrangement so that the fuel, which is a gas in this case, may be warmed and/or pressurized before delivery to the vehicle under high pressure, typically 350 bars or 700 bars. The conditioning arrangement is connected to at least a fuel dispensing unit 1. The conditioning arrangement supply gas in liquid state to the fuel dispensing unit 1 that deliver gas under gaseous state to the vehicle.

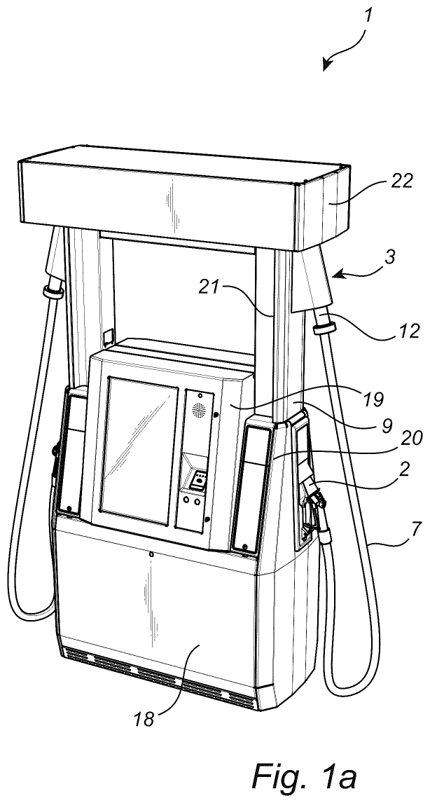

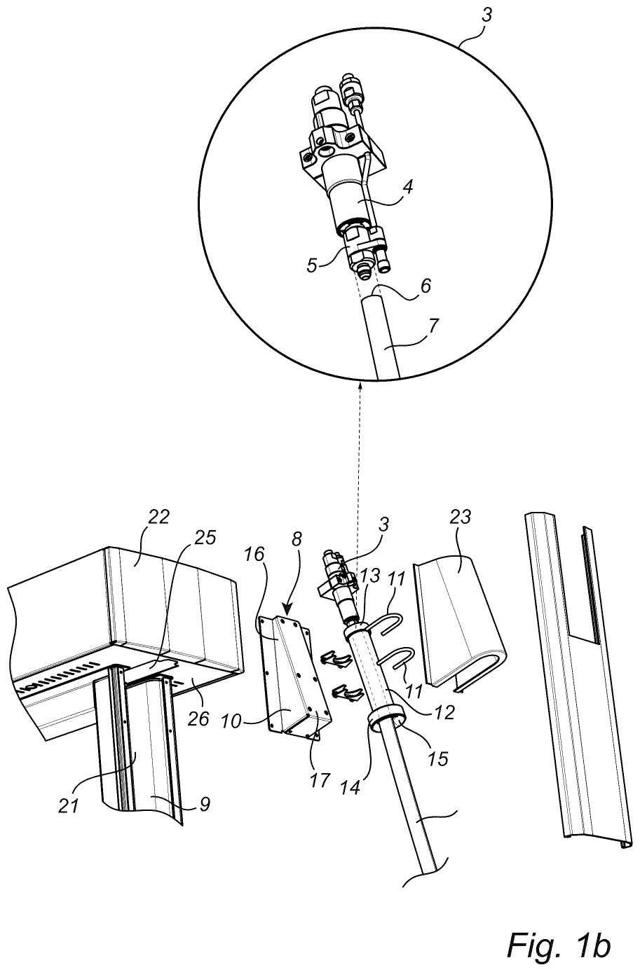

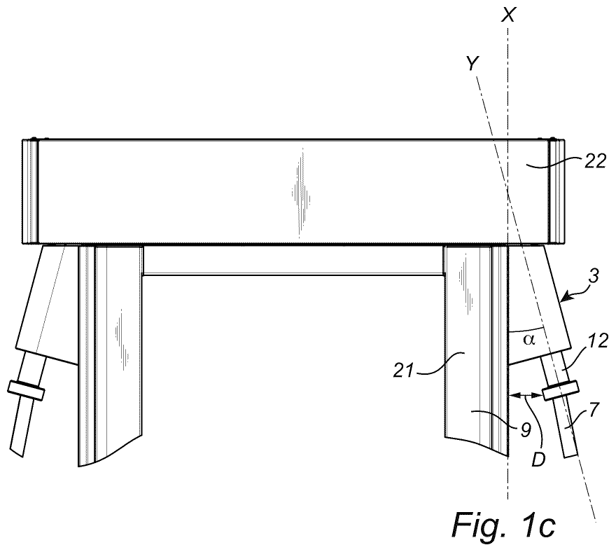

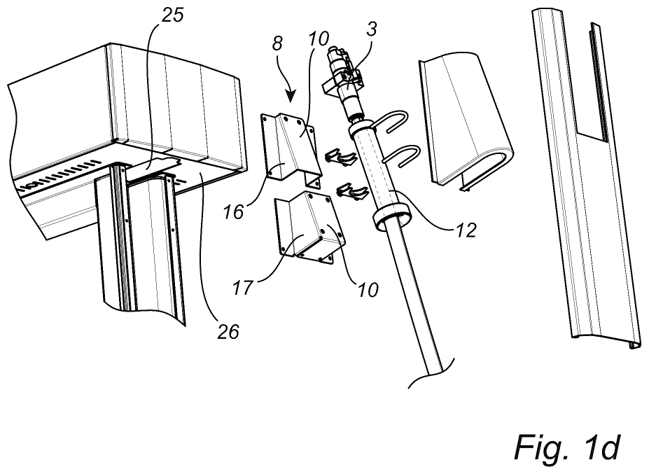

FIG. 1A-FIG. 1C illustrate an exemplary embodiment of a fuel dispensing unit 1 for delivering hydrogen according to the present invention. The fuel dispensing unit 1 has a breakaway device 3 comprising a first shut-off valve unit 4 connected to a fuel supply line (not shown) of the fuel dispensing unit 1 and a second shut-off valve unit 5 connected to a first end 6 of a fuel hose 7. The first shut-off valve unit 4 and the second shut-off valve unit 5 are intended to be disconnected when a predetermined tractive force from the fuel hose 7 is exceeded to separate the fuel hose 7 from the fuel dispensing unit 1 in case of a vehicle drive off.

A tilting means 8 is fixed to an outer side portion 9 of the fuel dispensing unit 1. The intention of the tilting means 8 is to support the breakaway device 3 in a manner such that it is inclined at a predetermined angle α with respect to the outer side portion 9 of the fuel dispensing unit 1. In this specific embodiment, the tilting means 8 comprises a triangular support element 10 with a triangular section and onto which the breakaway device 3 is arranged. This way, the breakaway device 3 is inclined in relation to the surface of the fuel dispensing unit 1 to which the tilting means 8 is attached or fixed by means of a fixing means 11. Put differently, the outer side portion 9 extends along a vertical axis X and the breakaway device 3 extends along an axis Y which is inclined at an angle α in relation to the vertical axis X.

The fuel dispensing unit 1 has a hose guiding means 12, preferably constituted by a tube element, with a first portion 13 connected to the second shut-off valve unit 5 of the breakaway device 3 and a second portion 14 comprising a hose outlet 15. In this specific embodiment, the hose guiding means 12 is arranged in connection with the tilting means 8 such that the second portion 14 of the guiding means 12 is positioned at a predetermined distance D from the outer side portion 9 of the fuel dispensing unit 1. The distance D is preferably within the range of 70 mm to 100 mm and even more preferably about 80 mm.

Put differently, the tilting means 8 is used to incline both the breakaway device 3 and the hose guiding means 12, simultaneously, and at the same angle α with respect to the outer side portion 9 of the fuel dispensing unit 1. The angle α is preferably within the range of 10 degrees and 40 degrees and even more preferably about 15 degrees.

In this embodiment, the triangular support element 10 of the tilting means 8 comprises a first section 16 having a first outermost width which is located near the first shut-off valve unit 4 and a second section 17 having a second outermost width which is located near the second portion 14 of the guiding means 12. The first outermost width being smaller than the second outermost width such that a triangular shape is achieved.

The embodiment of the fuel dispensing unit 1 in FIG. 1A has a hydraulics compartment 18 placed on the ground, an electronics compartment 19 placed on top of the hydraulics compartment 18 and two nozzle boot modules 20, one on each side of the electronics compartment 19. A column 21 extends from each nozzle boot module 20, respectively, up to a top module 22 carried by the two columns 21. Here, the outer side portion 9 on each side of the fuel dispensing unit 1 is constituted by the column 21 extending between the nozzle boot module 20 and the top module 22. Thus, the tilting means 8 is arranged directly on the column 21, on its outermost side. The hose guiding means 12—with the second shut-off valve unit 5 of the breakaway device 3 connected to the first portion 13 thereof—is placed directly onto the tilting means 8 and fixed by the fixing means 11. The inclined breakaway device 3 is arranged on the column 21 such that the second shut-off valve unit 4 of the breakaway device 3 is oriented towards the nozzle boot module 20 of the fuel dispensing unit 1. Put differently, the fuel hose 7 extends from the breakaway device 3 and downwardly towards a ground on which the fuel dispensing unit 1 is placed. A cover 23 is provided to protect the tilting means 8 and at least a part of the guiding means 12.

The fixing means 11 comprises two semi-annular clamps 11 surrounding the hose guiding means 12 and fixing the hose guiding means 12 to the triangular support element 10. The clamps 11, respectively, in this example, consist of a u-shaped rod and a sheet metal part clamping the hose guiding means 12 to the triangular support element 10, secured with two nuts.

An opening 25 is provided at a lower face 26 of the top box 22 enabling insertion of at least the first shut-off valve unit 4 into the top box 22. In FIG. 1D, another exemplary embodiment of the tilting means 8 is illustrated. In this embodiment, the first section 16 and the second section 17 of the triangular support element 10 of the tilting means 8 are spaced apart in a vertical direction. The first section 16 has a first outermost width which is located near the first shut-off valve unit 4 and the second section 17 has a second outermost width which is located near the second portion 14 of the guiding means 12, wherein the first outermost width being smaller than the second outermost width.

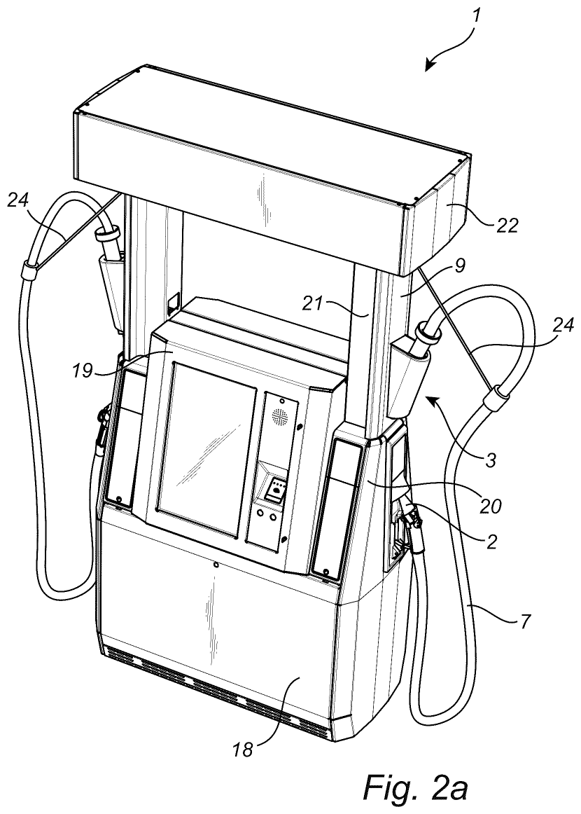

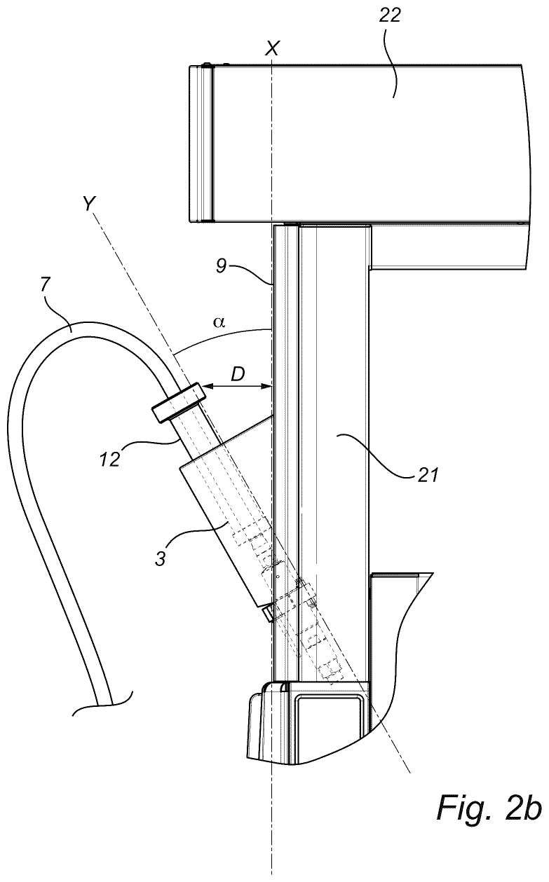

FIG. 2A and FIG. 2B illustrate another exemplary embodiment of a fuel dispensing unit 1. In this embodiment, the inclined breakaway device 3 is arranged on the column 21 such that the second shut-off valve unit 4 of the breakaway device 3 is oriented toward the top module 22 of the fuel dispensing unit 1. Put differently, the fuel hose 7 extends from the breakaway device 3 and upwardly towards a direction opposite to the ground on which the fuel dispensing unit 1 is placed. An elastic element 24, provided on each side of the fuel dispensing unit 1, is connected to the fuel hose 7 at one end and to the fuel dispensing unit 1 at the other end. The elastic element 24 is adapted to pull the fuel hose towards the fuel dispensing unit 1.

When a customer is about to refuel a vehicle, the nozzle 2 is removed from its nozzle boot located in the nozzle boot module 20 and placed in the vehicle tank inlet. From there, the refuelling process can be completed. Should the user forget to remove the nozzle 2 from the vehicle tank inlet before driving off, the first and second shut-off valve units 4, 5 will detach from each other, as soon as a predetermined tractive force applied from the fuel hose 7 is exceeded, to separate the fuel hose 7 from the fuel dispensing unit 1. The hose guiding means 12 does not disconnect during the drive-off and remains fixed to the tilting means 8. The second shut-off valve unit 5 passes through the hose guiding means 12. This way, any damage to the fuel dispensing unit 1 as well as to the vehicle can be avoided. Since the breakaway device 3 is arranged at an inclined manner, as described above, the force applied to column 21 of the fuel dispensing unit 1—as well as on the vehicle tank inlet—will be reduced significantly. When the second shut-off valve unit 5 passes through the hose guiding means 12, it is thus guided by the hose guiding means 12 and deviated far from the column 21.

It is understood that other variations in the present invention are contemplated and, in some instances, some features of the invention can be employed without a corresponding use of other features. Accordingly, it is appropriate that the appended claims be construed broadly in a manner consistent with the scope of the invention.

For instance, the breakaway device 3, the tilting means 8 and the hose guiding means 12 may be varied and may have any suitable size and shape without deviating from the scope of protection of the application.

The tilting means 8 could merely exist of one or several elements adapted to incline the breakaway device 3, such as, for example, two separate elements projecting horizontally, at different distances, from portion of the fuel dispensing unit 1 where the breakaway device 3 is to be arranged. A first element having a smaller length could be fixed on the column near the first portion 13 of the hose guiding means 12 and a second element having a longer length could be fixed on the column near the second portion 14 of the hose guiding means 12.

1. A dispensing unit, comprising:
a breakaway coupling comprising a first shut-off valve connected to a fuel supply line of the dispensing unit and a second shut-off valve connected to a first end of a hose, the hose comprising a nozzle at a second end of the hose;
wherein the first shut-off valve and the second shut-off valve are configured to disconnect when a predetermined tractive force from the hose is exceeded to separate the hose from the fuel dispensing unit; and
a ramp fixed to an outer side portion of the dispensing unit and configured to support the breakaway coupling such that the breakaway device is inclined at a predetermined angle with respect to the outer side portion of the dispensing unit.

2. The dispensing unit according to claim 1, further comprising a conduit having a first portion connected to the second shut-off valve of the breakaway coupling and a second portion comprising a hose outlet, wherein the conduit is arranged in connection with the ramp such that the second portion of the conduit is positioned at a predetermined distance from the outer side portion of the dispensing unit.

3. The dispensing unit according to claim 2, wherein the conduit comprises a tube.

4. The dispensing unit according to claim 1, wherein the ramp comprises a triangular support portion having a triangular section and onto which the breakaway coupling is arranged.

5. The dispensing unit according to claim 4, wherein the triangular support portion comprising a first section having a first outermost width which is located near the first shut-off valve and a second section having a second outermost width which is located near the second portion of the conduit, the first outermost width being smaller than the second outermost width.

6. The dispensing unit according to claim 5, wherein the first section and the second section are spaced apart in a vertical direction.

7. The dispensing unit according to claim 4, wherein the tube is fixed to the triangular support portion with at least one fastener.

8. The dispensing unit according to claim 1, wherein the predetermined angle between the inclined breakaway coupling and the outer side portion of the dispensing unit is preferably within the range of 10 degrees and 40 degrees.

9. The dispensing unit according to claim 2, wherein the predetermined distance between the second portion of the conduit and the outer side portion of the fuel dispensing unit ranges from 70 mm to 100 mm.

10. The dispensing unit according to claim 1, wherein the outer side portion of the dispensing unit comprises a column extending vertically between an upper portion and a lower portion of the fuel dispensing unit.

11. The dispensing unit according to claim 1, wherein the inclined breakaway coupling is arranged on the outer side portion such that the second shut-off valve of the breakaway coupling is oriented toward the lower portion of the dispensing unit.

12. The dispensing unit according to claim 1, wherein the inclined breakaway coupling is arranged on the outer side portion such that the second shut-off valve of the breakaway coupling is oriented toward the upper portion of the dispensing unit.

13. The dispensing unit according to claim 12, wherein an elastic element is connected to the hose at one end and to the dispensing unit at the other end, the elastic element being configured to pull the hose towards the dispensing unit.

14. The dispensing unit according to claim 2, wherein the ramp and at least a part of the conduit are protected by a cover.
